(19) United States
(12) Patent Application Publication
(10) Pub. No.: US 2009/0228442 A1
(43) Pub. Date: Sep. 10, 2009

(54) SYSTEMS AND METHODS FOR BUILDING A DOCUMENT INDEX

(75) Inventors: Randy Adams, Menlo Park, CA (US); Joe E. Rouvier, Sunnyvale, CA (US)

Correspondence Address: JONES DAY, 222 EAST 41ST ST, NEW YORK, NY, 10017, US

(73) Assignee: SearchMe, Inc.

(21) Appl. No.: 12/045,691

(22) Filed: Mar. 10, 2008

(51) Int. Cl. G06F 17/30; G06F 17/00

(52) U.S. Cl. 707/3; 707/102; 707/E17.001; 707/E17.014

(57) ABSTRACT

Systems and methods for building a document or vertical index are provided in which a document comprising code for a web page on the Internet is obtained. A static graphic representation of the web page is rendered thereby building a word map that has, for each respective word in a plurality of words, areas in the representation occupied by the word. The word map having (i) an instance of a word, (ii) x- and y- coordinates of where the word appears in the representation, and (iii) a size of the area in the representation occupied by the word, is stored. A document or vertical index including the document is built such that x- and y- coordinates of the word in the representation or the size of the area in the representation occupied by the word is used as a feature of the document in the document or vertical index.

### 1. FIELD OF THE INVENTION

The present application relates generally to information search and retrieval. More specifically, systems and methods are disclosed for processing a plurality of documents. Such processed documents can be used to construct a document index that improves how search results are viewed by a search requester.

### 2. BACKGROUND

The use of conventional search engines to identify relevant documents requires significant concentration on the part of the user. Search results are typically in the format of between 10 and 100 words extracted from each web page that is deemed by the conventional search engine to be relevant to a search query. Thus, to find the most relevant results to a given search query, a searcher must read many of these 10 to 100 word web page extracts. Given the above background, what is needed in the art are improved systems and methods for building a document index.

### 3. SUMMARY

The present application addresses the deficiencies present in the known art. One aspect of the present invention provides systems and methods for building a document index or a vertical index in which a document comprising code for a web page on the Internet is obtained. A static graphic representation of the web page is rendered thereby building a word map that has, for each respective word in a plurality of words, areas in the representation occupied by the respective word. The word map comprising (i) an instance of a word, (ii) x- and y- coordinates of where the word appears in the representation, and (iii) a size of the area in the representation occupied by the word, is stored. A document index or a vertical index including the document is built such that x- and y- coordinates of a word in the representation of the document or the size of the area in the representation occupied by the first word is used as a feature of the document in the document index or the vertical index.

Another aspect of the present invention provides a method for building a document index or a vertical index in which a first document is obtained, where the first document comprises code for a web page that corresponds to the first document. A static graphic representation of the web page corresponding to the first document is rendered. In addition to generating the static graphic representation, the rendering generates a word map for the static graphic representation that comprises, for each respective word in a plurality of words in the first document, each area in the static graphic representation that is occupied by the respective word. The word map for the web page is stored. The stored word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word. A document index or a vertical index comprising a plurality of documents is constructed. The plurality of documents comprises the first document and an x-coordinate and the y-coordinate that represents where an instance of the first word that appears in the static graphic representation of the web page and/or the size of the area in the static graphic representation of the web page occupied by the instance of the first word is used as a feature of the first document that is indexed in the document index or the vertical index.

In some embodiments, the method further comprises receiving a submitted search query from a search requester that includes the first word. Further, a plurality of search results relevant to the submitted search query is obtained from the document index or the vertical index, where the first document is included in the plurality of search results when the x-coordinate and the y-coordinate that represents where the instance of the first word that appears in the static graphic representation of the web page is in a first area of the static graphic representation and the first document is not included in the plurality of search results when the x-coordinate and the y-coordinate that represents where the instance of the first word that appears in the static graphic representation of the web page is in a second area of the static graphic representation, where the first area of the static graphic representation is different than the second area of the static graphic representation.

In some embodiments, the method further comprises receiving a submitted search query from a search requester that includes the first word and obtaining a plurality of search results relevant to the submitted search query from the document index or the vertical index, where the first document is included in the plurality of search results when the size of the area in the static graphic representation of the web page occupied by the instance of the first word is greater than or equal to a first threshold size and the second document is not included in the plurality of search results when the size of the area in the static graphic representation of the web page occupied by the instance of the first word is less than or equal to a first threshold size.

In some embodiments, the method further comprises receiving a submitted search query from a search requester that includes the first word and obtaining a plurality of search results relevant to the submitted search query from the document index or the vertical index, where the determination of whether the first document is included in the plurality of search results is based, at least in part, upon a value of the x-coordinate and a value of the y-coordinate that represents where the instance of the first word that appears in the static graphic representation of the web page.

In some embodiments, the method further comprises receiving a submitted search query from a search requester that includes the first word and obtaining a plurality of search results relevant to the submitted search query from the document index or the vertical index, where the determination of whether the first document is included in the plurality of search results is based, at least in part, upon a size of the area in the static graphic representation of the web page occupied by the instance of the first word.

In some embodiments, the method further comprises receiving a submitted search query from a search requester that includes the first word obtaining a plurality of search results relevant to the submitted search query from the document index or the vertical index, where the determination of whether the first document is included in the plurality of search results is based, at least in part, upon a number of times the first word appears in the first document.

Another aspect of the disclosure provides a computer program product for use in conjunction with a computer system, the computer program product comprising a computer readable storage medium and a computer program mechanism embedded therein, the computer program mechanism comprising instructions for carrying out any of the methods disclosed herein.

Another aspect of the disclosure provides a computer program product for use in conjunction with a computer system, the computer program product comprising a computer readable storage medium and a computer program mechanism embedded therein, the computer program mechanism comprising instructions for obtaining a first document, where the first document comprises code for a web page that corresponds to the first document as well as instructions for rendering a static graphic representation of the web page corresponding to the first document, where the rendering comprises generating a word map for the static graphic representation that comprises, for each respective word in a plurality of words in the first document, each area in the static graphic representation that is occupied by the respective word. The computer program mechanism further comprises instructions for storing the word map for the web page, where the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word. The computer program mechanism further comprises instructions for building a document index or a vertical index of a plurality of documents, the plurality of documents comprising the first document, where the x-coordinate and the y-coordinate that represents where the instance of the first word that appears in the static graphic representation of the web page or the size of the area in the static graphic representation of the web page occupied by the instance of the first word is used as a feature of the first document that is indexed in the document index or the vertical index.

Another aspect of the present invention provides a computer, comprising a main memory, a processor and one or more programs, stored in the main memory and executed by the processor, the one or more programs collectively including instructions for carrying out any of the methods disclosed herein.

Another aspect of the present invention provides a computer, comprising a main memory, a processor and one or more programs, stored in the main memory and executed by the processor, the one or more programs collectively including instructions for obtaining a first document, where the first document comprises code for a web page that corresponds to the first document. The one or more programs also collectively including instructions for rendering a static graphic representation of the web page corresponding to the first document, where the rendering comprises generating a word map for the static graphic representation that comprises, for each respective word in a plurality of words in the first document, each area in the static graphic representation that is occupied by the respective word. The one or more programs also collectively including instructions for storing the word map for the web page, where the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word. The one or more programs also collectively including instructions for building a document index or a vertical index of a plurality of documents, the plurality of documents comprising the first document, wherein the x-coordinate and the y-coordinate that represents where the instance of the first word that appears in the static graphic representation of the web page or the size of the area in the static graphic representation of the web page occupied by the instance of the first word is used as a feature of the first document that is indexed in the document index or the vertical index.

### 4. BRIEF DESCRIPTION OF THE DRAWINGS

FIG. 1 illustrates a system in accordance with an aspect of the present disclosure.

FIG. 2 illustrates a search query prompt for searching one or more document repositories in accordance with an embodiment of the present disclosure.

FIG. 3 illustrates a search query prompt in accordance with an embodiment of the present disclosure, in which a partial search query has been entered, and responsive thereto, suggested vertical categories have been provided.

FIG. 4 illustrates a search query prompt in accordance with an embodiment of the present disclosure, in which a more complete search query has been entered relative to FIG. 3, and responsive thereto, updated suggested vertical categories have been provided.

FIG. 5 illustrates the display of a first static graphic representation from the search query of FIG. 4 in a center position of a graphic output device and displaying a second static graphic representation from the search results for the search query of FIG. 4 in a first off-center position of the graphic output device, where the second static graphic representation is displayed rotated about a first axis of rotation that lies between the center position and the first off-center position, in accordance with an aspect of the present disclosure.

FIG. 6 illustrates how, responsive to a selection of the second static graphic representation in the first off-center position of FIG. 5, (i) the first static graphic representation is shifted to a second off-center position (to the left of the center position), thereby causing the first static graphic representation to be displayed at the second off-center position rotated about a second axis of rotation that lies between the center position and the second off-center position, (ii) the second static graphic representation is shifted to the center position, thereby causing the second static graphic representation to be displayed at the center position in a manner that is no longer rotated about the first axis of rotation, and (iii) a third static graphic representation is displayed in the first off-center position (to the right of the center position), where the third static graphic representation is displayed rotated about the first axis of rotation that lies between the center position and the first off-center position in accordance with an aspect of the present disclosure.

FIG. 7 further illustrates how, relative to FIG. 6, static graphic representations can be shifted in accordance with an aspect of the present disclosure.

FIG. 8 illustrates how the search term “hydroxyl” is highlighted (shown by ovals) in each of the displayed static graphic representations in the search result responsive to the search term “hydroxyl” in accordance with an aspect of the present disclosure.

FIG. 9 illustrates how the search terms “hydroxyl” and “chemical” are highlighted in each of the displayed static graphic representations in the search result responsive to the search terms “hydroxyl” and “chemical” in accordance with an aspect of the present disclosure.

FIG. 10 illustrates how the search term “restaurant” is highlighted in each of the displayed static graphic representations in the search result responsive to the search term “hydroxyl” in accordance with an aspect of the present disclosure.

FIG. 11 illustrates how text-based representations of search hits can be provided in conjunction with the static graphic representations of search hits in accordance with an embodiment of the present invention.

FIG. 12 illustrates how a common toggle bar can be used to jointly scroll through text-based representations of search hits and static graphic representations of search hits in accordance with an embodiment of the present invention.

FIG. 13 illustrates the architecture of a vertical index in accordance with one embodiment of the present disclosure.

FIG. 14 illustrates an exemplary method in accordance with an embodiment of the present disclosure.

Like reference numerals refer to corresponding parts throughout the several views of the drawings.

### 5. DETAILED DESCRIPTION

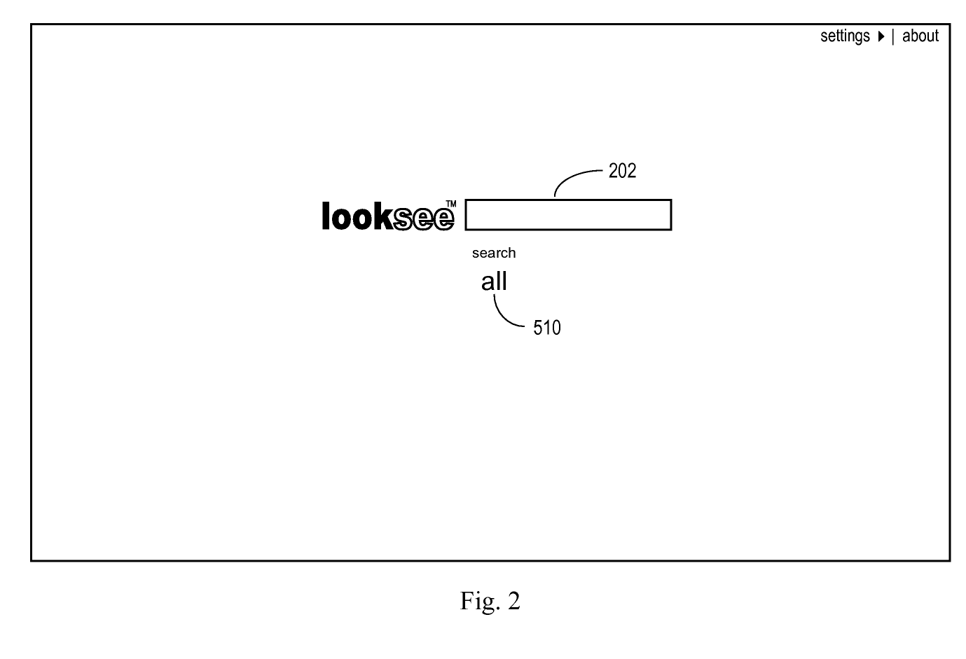

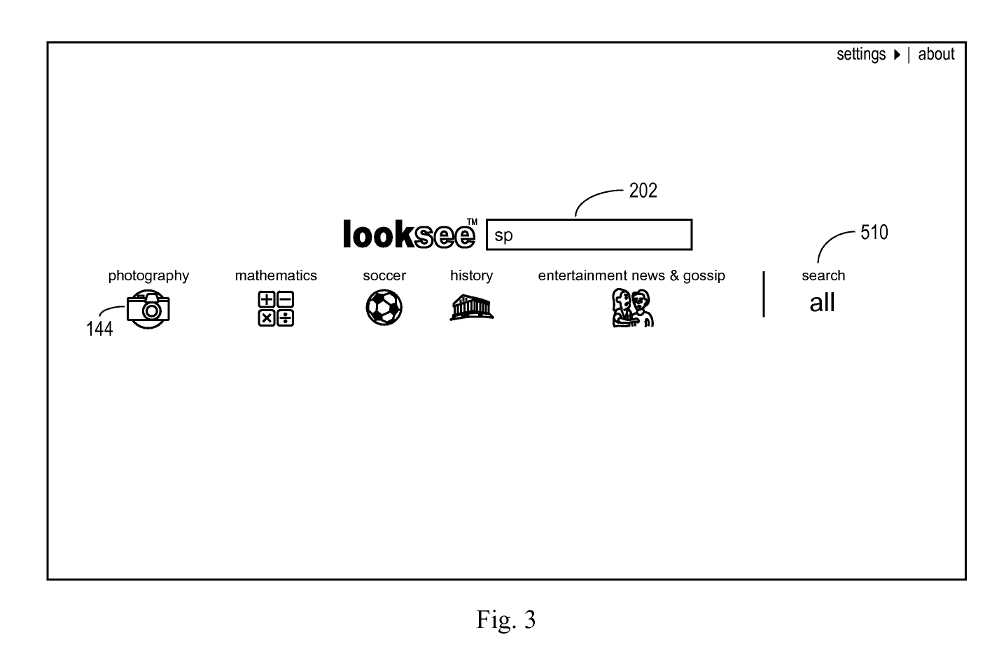

The present disclosure details novel advances over known search engines. A search query or a partial search query is submitted to a search engine. Upon receiving the search query or partial search query, the search engine optionally identifies vertical collections in an optional vertical collection index that are relevant to the search query. In embodiments that make use of vertical collections, the names of the candidate vertical collections are then returned to a client computer where they are displayed. For example, consider FIG. 2, which comprises a prompt 202 for a search query. Turning to FIG. 3, a search requester enters the partial search query “sp” into prompt 202. In response, the search engine returns five vertical collections 144 that match the partial search query: photography, mathematics, soccer, history, and entertainment news & gossip. The user can select one of the optional vertical collections 144 from FIG. 3 and proceed to search the vertical collection 144 with the original search expression or new search expressions. Alternatively, the user can continue typing in a search query. Alternatively still, the user can press the “Search All” button 510 and search a document index that represents the entire Internet or intranet with the search expression “sp.” In some embodiments, there are no vertical collections offered and the user simply presses a predetermined key, such as carriage return, or the search all button, or some logical equivalent (e.g., a predetermined mouse key click or combination of clicks) and a document index that represents the entire Internet, intranet, or some other distributed set of documents is searched. As used herein, a document index represents the entire Internet when documents were pulled from more than 100 locations, more than 1000 locations, more than 100,000 locations, more than one million, or more than one billion locations on the Internet, an intranet, or some set of documents distributed amongst a plurality of computers (e.g., more than 10, more than 100 computers).

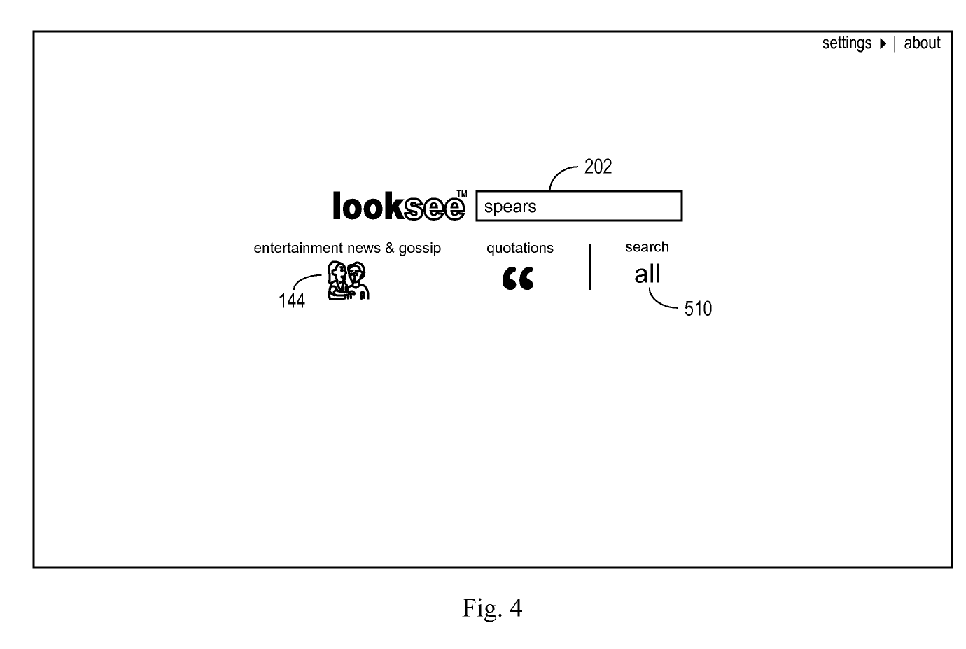

Turning to FIG. 4, the search requester chooses to complete the expression “sp” so that it reads “spears.” In response, the search engine optionally returns two vertical collections that match the updated search query: entertainment news & gossip as well as quotations. In embodiments that provide vertical collections, the user can select one of the vertical collections 144 from FIG. 4 and proceed to search the vertical collection with the original search expression or new search expressions. Alternatively, the user can continue typing in a search query. Alternatively still, the user can press the “Search All” button 510 and search a document index that represents the entire Internet or intranet with the search expression “spears.” As stated before, in some embodiments, no vertical collections are used and the user simply has the option to search a predetermined document index.

As set forth above, in some embodiments, vertical collections are used rather than an index that represents the entire Internet. A “vertical collection” comprises a set of documents (e.g., URLs, websites, etc.) that relate to a common category. For example, web pages pertaining to sailboats constitute a “sailboat” vertical collection. Web pages pertaining to car racing constitute a “car racing” vertical collection. In some embodiments, users search a vertical collection so that only documents relevant to the category or categories represented by the vertical collection are returned to the user. Advantageously, the present disclosure provides systems and methods for helping a searcher identify the right vertical collection to search. In some embodiments, users search a document index representative of the entire Internet or intranet rather than a vertical collection. More information on vertical collection suggestion technology that can be used in the systems and methods described herein is disclosed in United States Patent Publication No. 20070244863 entitled “Systems and Methods for Performing Searches within Vertical Domains” and United States Patent Publication No. 20070244862 entitled “Systems and Methods for Ranking Vertical Domains,” each of which is hereby incorporated by reference herein in its entirety.

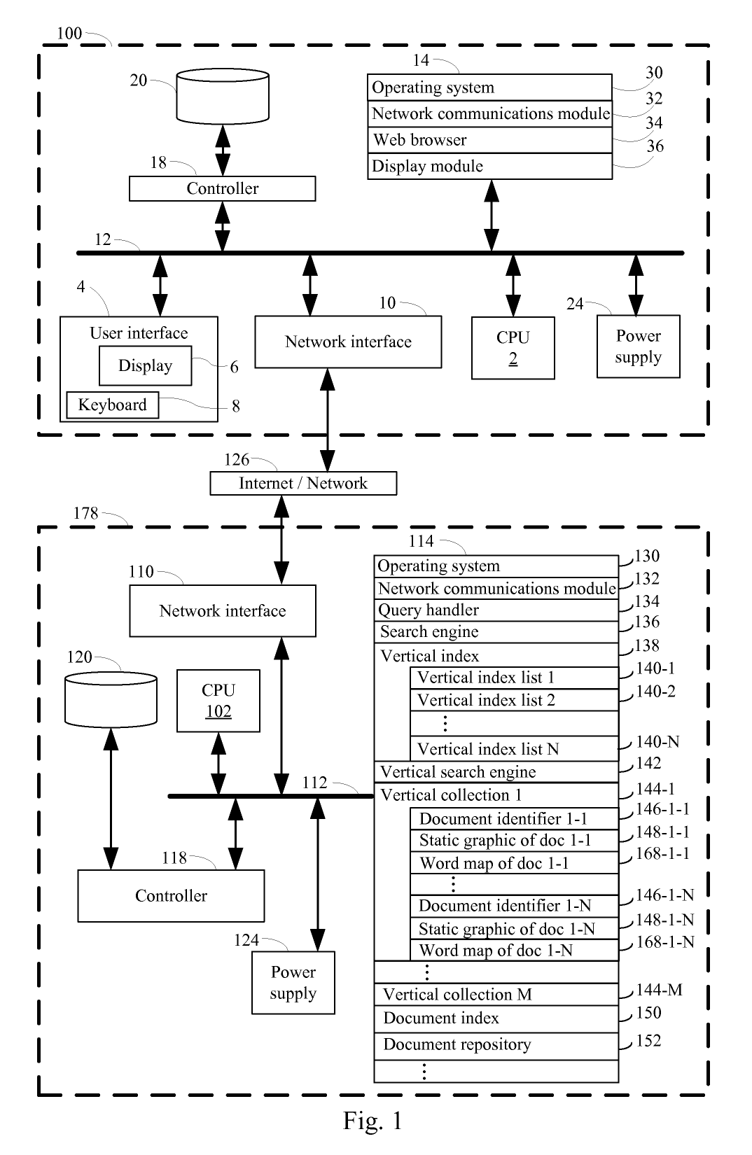

Now that an overview of the novel search query process and its advantages have been provided, a more detailed description of a system in accordance with the present application is described in conjunction with FIG. 1. FIG. 1 illustrates a search engine server 178 in accordance with one embodiment of the present disclosure. In some embodiments, search engine server 178 is implemented using one or more (not shown) computer systems. It will be appreciated by those of skill in the art that search engines designed to process large volumes of search queries, such as search engine server 178, may use complicated computer architectures not shown in FIG. 1. For instance, a front end set of servers may be used to receive and distribute search queries from numerous client 100s among a set of back-end servers that actually process the search queries. In such a system, vertical search engine server 178 as shown in FIG. 1 would be one such back-end server.

Search engine 178 will typically have one or more processing units (CPUs) 102, a network or other communications interface 110, a memory 114, one or more magnetic disk storage devices 120 accessed by one or more controllers 118, one or more communication busses 112 for interconnecting the aforementioned components, and a power supply 124 for powering the aforementioned components. Data in memory 114 can be seamlessly shared with non-volatile memory 120 using known computing techniques such as caching. Memory 114 and/or memory 120 can include mass storage that is remotely located with respect to the central processing unit(s) 102. In other words, some data stored in memory 114 and/or memory 120 may in fact be hosted on computers that are external to vertical search engine 178 but that can be electronically accessed by vertical search engine over an Internet, intranet, or other form of network or electronic cable (illustrated as element 126 in FIG. 1) using network interface 110.

Memory 114 preferably stores:
an operating system 130 that includes procedures for handling various basic system services and for performing hardware dependent tasks;
a network communication module 132 that is used for connecting search engine 178 to various client computers such as client computers 100 (FIG. 1) and possibly to other servers or computers via one or more communication networks, such as the Internet, other wide area networks, local area networks (e.g., a local wireless network can connect the client computers 100 to vertical search engine 178), metropolitan area networks, and so on;
a query handler 134 for receiving a search query from a client computer 100;
a search engine 136 for searching either a selected optional vertical collection 144 or a document index 150, where document index 150 can, for example, represent the entire Internet or an intranet, for documents related to a search query and for forming a group of ranked documents that are related to the search query;
an optional vertical index 138 comprising a plurality of vertical indexes 140, where each vertical index is an index of a corresponding vertical collection 144;
an optional vertical search engine 142, for searching optional vertical index 138 for one or more vertical index lists 140 that are relevant to a given search query;
an optional plurality of vertical collections 144, each optional vertical collection 144 comprising a plurality of document identifiers 146 and, for each respective document identifier 146, a static graphic representation 148 of the source URL for the document represented by the respective document identifier 146 as well as a word map 168 for the static graphic representation that comprises, for each respective word in a plurality of words in the document, each area in the static graphic representation that is occupied by the respective word;
a document index 150 comprising a list of terms, a document identifier uniquely identifying each document associated with terms in the list of terms, and the sources of these documents; and
a document repository 152 comprising a source URL or a reference to a source URL for each document in the document repository and (ii) a static graphic representation of the source URL for each document in the document repository.

Search engine 178 is connected via Internet/network 122 to one or more client devices. FIG. 1 illustrates the connection to only one such client device 100. However, in practice, search engine 178 can be connected to 10 or more of the client devices 100, 100 or more of the client devices 100, more typically 1000 or more of the client devices 100, more typically still 10,000 or more of the client devices 100, and more typically still, 100,000 or more of the client devices 100. In typical embodiments, a client device 100 comprises:
one or more processing units (CPUs) 2;
a network or other communications interface 10;
a memory 14;
optionally, one or more magnetic disk storage devices 20 accessed by one or more optional controllers 18;
a user interface 4, the user interface 4 including a display 6 and a keyboard or other input device 8;
one or more communication busses 12 for interconnecting the aforementioned components; and
a power supply 24 for powering the aforementioned components.

In some embodiments, data in memory 14 can be seamlessly shared with non-volatile memory 20 using known computing techniques such as caching. In some embodiments the client device 100 does not have a magnetic disk storage device. For instance, in some embodiments, the client device 100 is a portable handheld computing device and network interface 10 communicates with Internet/network 126 by wireless means.

Memory 14 preferably stores:
an operating system 30 that includes procedures for handling various basic system services and for performing hardware dependent tasks;
a network communication module 32 that is used for connecting client device 100 to search engine 178;
a web browser 34 for receiving a search query from client computer 100; and
a display module 36 for instructing the web browser 34 on how to display search results relevant to a submitted search query.

In some embodiments, a document index 150 is constructed by scanning documents on the Internet and/or intranet for relevant search terms. An exemplary document index 150 is illustrated below:

| Term | Document Identifier |
|---|---|
| term 1 | docID₁ₐ, . . . , docID₁ₓ |
| term 2 | docID₂ₐ, . . . , docID₂ₓ |
| term 3 | docID₃ₐ, . . . , docID₃ₓ |
| . | |
| . | |
| . | |
| term N | docID_{Na}, . . . , docID_{Nx} |

In some embodiments, the document index 150 is constructed by conventional indexing techniques. Exemplary indexing techniques are disclosed in, for example, United States Patent publication 20060031195, which is hereby incorporated by reference herein in its entirety. By way of illustration, in some embodiments, a given term may be associated with a particular document when the term appears more than a threshold number of times in the document. In some embodiments, a given term may be associated with a particular document when the term achieves more than a threshold score. Criteria that can be used to score a document relative to a candidate term include, but are not limited to, (i) a number of times the candidate term appears in an upper portion of the document, (ii) a normalized average position of the candidate term within the document, (iii) a number of characters in the candidate term, and/or (iv) a number of times the document is referenced by other documents. High scoring documents are associated with the term. In preferred embodiments, document index 150 stores the list of terms, a document identifier uniquely identifying each document associated with terms in the list of terms, and, optionally, the scores of these documents. In some embodiments, the document identifier uniquely identifying each document is a uniform resource location (URL) or a value or number that represents a uniform resource location (URL). Those of skill in the art will appreciate that there are numerous methods for associating terms with documents in order to build document index 150 and all such methods can be used to construct document index 150 of the present invention.

There is no limit to the number of terms that may be present in document index 150. Moreover, there is no limit on the number of documents that can be associated with each term in document index 150. For example, in some embodiments, between zero and 100 documents are associated with a search term, between zero and 1000 documents are associated with a search term, between zero and 10,000 documents are associated with a search term, or more than 10,000 documents are associated with a search term within document index 150. Moreover, there is no limit on the number of search terms to which a given document can be associated. For example, in some embodiments, a given document is associated with between zero and 10 search terms, between zero and 100 search terms, between zero and 1000 search terms, between zero and 10,000 search terms, or more than 10,000 search terms.

In the context of this application, documents are understood to be any type of media that can be indexed and retrieved by a search engine, provided that such documents code for a unique web page that is available on the Internet. Thus, in the present invention, there is a one-to-one correspondence between a document and a unique web page available on the Internet. A document may code for one or more web pages as appropriate to its content and type. In the present disclosure, there are many documents indexed. Typically, there are more than one hundred thousand documents, more than one million documents, more than one billion documents, or even more than one trillion documents present in document index 150.

In a preferred embodiment, for each document referenced by document index 150, search engine server 178 stores or can electronically retrieve (i) the source document or a document identifier 146 (document reference) that can be used to retrieve the source document, (ii) a static graphic representation 148 of the source document, and (iii) a word map 168 for the static graphic representation that comprises, for each respective word in a plurality of words in the source document, each area in the static graphic representation that is occupied by the respective word. Of course, some documents reference by document index 150 may not contain words and, consequently, for such documents there will be no word map 168 or the word map 168 will contain no words. In some embodiments, the document identifier 146 is stored in document index 150 while the static graphic representation 148 of the source document and the word map 168 are stored in document repository 152. In some embodiments, the document identifier 146, the static graphic representation 148, and the word map 168 of each source document tracked by search engine server 178 is stored in document index 150. In some embodiments, the document identifier 146, the static graphic representation 148, and the word map 168 of the each source document tracked by search engine server 178 is stored in document repository 152. It will be appreciated that document identifiers 146, static graphic representations 148, and word maps 168 may be stored in any number of different ways, either in the same data structure or in different data structures within search engine server 178 or in computer readable memory or media that is accessible to search engine server 178.

In some embodiments each static graphic representation of a document is a bitmapped or pixmapped image of a web page encoded by the code in the corresponding document. As used herein, a bitmap or pixmap is a type of memory organization or image file format used to store digital images. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in Windows that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats, such as JPEG, TIFF, PNG, and GIF, to name just a few, in which the bitmap image (as opposed to vector images) is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p.13, ISBN 0201848406 as well as Pachghare, 2005, Comprehensive Computer Graphics: Including C++, Laxmi Publications, p.93, ISBN 8170081858, each of which is hereby incorporated by reference herein in its entirety.

In typical uncompressed bitmaps, image pixels are generally stored with a color depth of 1, 4, 8, 16, 24, 32, 48, or 64 bits per pixel. Pixels of 8 bits and fewer can represent either grayscale or indexed color. An alpha channel, for transparency, may be stored in a separate bitmap, where it is similar to a greyscale bitmap, or in a fourth channel that, for example, converts 24-bit images to 32 bits per pixel. The bits representing the bitmap pixels may be packed or unpacked (spaced out to byte or word boundaries), depending on the format. Depending on the color depth, a pixel in the picture will occupy at least n/8 bytes, where n is the bit depth since 1 byte equals 8 bits. For an uncompressed, packed within rows, bitmap, such as is stored in Microsoft DIB or BMP file format, or in uncompressed TIFF format, the approximate size for a n-bit-per-pixel (2ⁿcolors) bitmap, in bytes, can be calculated as: size˜width×height×n/8, where height and width are given in pixels. In this formula, header size and color palette size, if any, are not included. Due to effects of row padding to align each row start to a storage unit boundary such as a word, additional bytes may be needed.

As stated above, a word map 168 for the static graphic representation 148 of a document comprises, for each respective word in a plurality of words in the document, each area in the static graphic representation that is occupied by the respective word. Advantageously, in the present invention, this word map is extracted by parsing the code for a unique web page encoded by a document and constructing a static graphic representation for the unique web page. For example, in some embodiments, the code for a unique web page that corresponds to a document is parsed in order to construct the bitmapped or pixmapped image of the web page. During this parsing, each word that is to be rendered in the bitmapped or pixmapped image is identified. Any applicable style sheets, HTML features, or other attributes are fully interpreted during this parsing so that the exact size and location and appearance of each word that is to be rendered in the bitmapped or pixmapped image is known. While such information is required for the bitmapped or pixmapped image it is also advantageously used to construct the word map 168 for the document. The contents of an exemplary word map 168 is shown in the following table:

| | | | | | | Font/ | Feature |
|---|---|---|---|---|---|---|---|
| | Instance | x-coordinate | y-coordinate | x-size | y-size | Point | (e.g., |
| Word | number | (pixels) | (pixels) | (pixels) | (pixels) | Size | attribute) |
| Hello | 1 | 125 | 300 | 10 | 400 | Times | Italic, |
| | | | | | | Roman/ | Underline |
| | | | | | | 12 | |
| | 2 | 497 | 400 | 12 | 400 | Times | Italic, |
| | | | | | | Roman/ | Underline |
| | | | | | | 10 | |
| Goodbye | 1 | 302 | 948 | 100 | 300 | Ariel/9 | Boldface |
| | 2 | 562 | 332 | 73 | 500 | Courier/9 | None |

From the table, it is apparent that a word map will contain information for each of a plurality of words that are encoded in the static graphic representation (e.g., bitmapped or pixmapped web page) corresponding to a document. In an exemplary word map 168, each instance of a word in the static graphic representation is listed along with some indicia of the size and location of the instance of the word in the static graphic representation. In some embodiments, if the size of the area occupied by a word is approximated as a rectangle, then the indicia for the size is a reference corner of the rectangle (e.g., the lower left hand corner, the lower right hand corner, the upper left hand corner, the upper right hand corner of the rectangle in the static graphic representation) coupled with an x-size and a y-size in pixels from the reference corner. In some embodiments, the size of the area occupied by a word is tracked by finding the center of the word map in the static graphic representation and then overlapping a two-geometric object such as a square, rectangle, ellipse or circle that encompasses the word in the word map. The area in the static graphic representation occupied by the word is then deeded to be the size of this two-geometric object. Of course any number of ways could be used to track the location and size of an instance of a word in the static graphic representation in the word map 168 and all such ways are within the scope of the present invention. In some embodiments, the size of the area in the word map 168 is tracked by indicating a starting location and orientation of the word and then using the point size and the font of the word, and any applicable attribute (e.g., underlining, bold-face, italics, etc.) to determine the size of the area occupied by the word in the static graphic representation. In some embodiments, the systems and methods of the present invention track the area occupied by a word in a static graphic representation even in instances where the word wraps from the far right hand side of one line of the static graphic representation to the far left hand side of the next line of the static graphic representation.

In some embodiments, the word map 168 tracks more than ten different words in a corresponding static graphic representation 148 and for each respective word in the more than ten different words, the location and the area in the static graphic representation 148 occupied by each instance of the respective word in the static graphic representation.

Advantageously, the features, such as those identified in the table above, of words in a document that are obtained from the process of rendering the static graphic representation can be used in the construction of the document index. By way of illustration, in some embodiments, a given term may be associated with a particular document based upon not only features such as how many times the term appears in the document, but also the location of the term in the static graphic representation, the size of the area in the static graphic representation occupied by a term, and attributes of the term in the static graphic representation such as italics, underlining, boldfacing, strikethrough, font color, shadow, font, or font size. Many of these features are not easily decipherable from the code for the web page in the document code. For example, in some instances the code for a web page of a document makes use of web style sheets. This is a form of separation of presentation and content for web design in which the markup (e.g., HTML or XHTML) of a webpage contains the page's semantic content and structure, but does not define its visual layout (style). Instead, the style is defined in an external stylesheet file using a language such as CSS or XSL. This design approach is identified as a “separation” because it largely supersedes the antecedent methodology in which a page's markup defined both style and structure. Thus, in many instances, because of the use of style sheets, embedded applets, complex JAVA scripts, and other complexities of code use to construct web pages, it is simply not possible to ascertain the location, size, and other features of a term in a document until the web page encoded by the document has been rendered into a static graphic representation such as a bitmapped or pixmapped image. In some embodiments, the static graphic representation is generated using a web browser for which source code is available, such as Mozilla Firefox, in which an extension is added that extracts features about each word as the browser is rendering a static graphic representation of the web page including where on the static graphic representation 148 the word will be located, the size of the word, and any attributes associated with the word. As used herein, a static graphic representation 148 of a web page can be an image of the rendered web page at a given instant in time or a time averaged representation of the web page over a period of time (e.g., one second or more, ten seconds or more, a minute or more, two minutes or more, etc.). Thus, a static graphic representation fully encompasses dynamic web pages that include applets such as ticker tapes or other dynamic components that cause the representation of the web page to change over time. Any dynamic components in a web page can either be ignored when constructing the word map for the document encoding the web page, averaged over a period of time, or a snapshot of such dynamic components (e.g., snapshots) can be used for the purposes of constructing the static graphic representation of the web page.

In some embodiments of the present application, vertical collections 144 are used. Vertical collections 140 are constructed using documents in document index 150 that pertain to a particular category. For example, one vertical collection 144 may be constructed from documents indexed by document index 150 that pertain to movies, another vertical collection 144 may be constructed from documents indexed by document index 150 that pertain to sports, and so forth. Vertical collections 144 can be constructed, merged, or split in a relatively straightforward manner. In some embodiments, there are hundreds of vertical collections 144 set up in this manner. In some embodiments, there are thousands of vertical collections 144 set up in this manner.

Once the document index 150 has been constructed, it is possible to construct the vertical index 138. To accomplish this, in some embodiments, each vertical collection 450 is inverted. In some embodiments, each vertical collection 144 has the form:

Vertical collection (V₁)₁₄₄₋₁

DocId₁₄₆₋₁₋₁
Static Graphic DocId₁₄₈₋₁₋₁
Word Map DocId₁₆₈₋₁₋₁
DocId₁₄₆₋₁₋₂
Static Graphic DocId₁₄₈₋₁₋₂
Word Map DocId₁₆₈₋₁₋₂
.
.
.
DocId_{146-1-P}
Static Graphic DocId_{148-1-P}
Word Map DocId_{168-1-P}

In some embodiments, each DocId in the vertical collection 144 further includes a document quality score. Inversion of each of the vertical collections 144 and the merging of each of these inverted vertical collections leads to an inverted document-vertical index having the following data structure:

Inverted document-vertical index

| Document | Associated vertical |
|---|---|
| identifiers | collections 144 |
| DocId₁₋₁ | Vₐ, . . . , Vₓ |
| DocId₁₋₂ | V_{b}, . . . , V_{y} |
| . | |
| . | |
| . | |
| DocId_{1-P} | V_{c}, . . . , V_{z} |
| DocId₂₋₁ | V_{d}, . . . , Vₐₐ |
| . | |
| . | |
| . | |

Thus, for each given document in document index 150, a list of vertical collections 144 associated with the given document can be obtained by taking the associated vertical collections for the given document from the inverted vertical collection. There can be several vertical collections 144 associated with any given document in this manner. Further, there is no requirement that each document be associated with a unique set of vertical collections 144.

Thus, as seen above, with the inverted document-vertical index, it is now possible to create a vertical index 138 by substituting the document identifiers in document index 150 with the corresponding vertical collections associated with such document identifiers as set forth in the inverted document-vertical index. In one approach, this is done by scanning the document index 150 on a termwise basis, and collecting the set of vertical collections 144 that are associated with the documents that are, themselves, associated with each term as set forth in the inverted document-vertical index. For example, consider a term 1 in the exemplary document index 150 presented above. According to document index 150, term 1 is associated with docID₁ₐ, . . . , docID₁ₓ. Thus, for each respective docIDᵢ in the set docID₁ₐ, . . . , docID₁ₓ, the inverted document-vertical index is consulted to determine which vertical collections 144 are associated with the respective docIDᵢ. Each of these vertical collections 144 are then associated with term 1 in order to construct a vertical index list 140 for term 1. Thus, starting with the entry for term 1 in document index 150,

| | |
|---|---|
| term 1 | docID₁ₐ, . . . , docID₁ₓ |

the set of vertical collections associated with docID₁ₐ, . . . , docID₁ₓ are collected from the inverted document-vertical index in order to construct the vertical index list 140:

| | |
|---|---|
| term 1 | V₁, V₂, . . . , V_{N} |

where each of V₁, V₂, . . . , V_{N} is a vertical collection identifier that points to a unique vertical collection 144. This data structure is a vertical index list 140. As illustrated, a vertical index list 140 is a list of vertical collection identifiers of vertical collections 144 sharing a definable attribute (e.g., “term 1”). If term 1 was “vacation,” than vertical index list 140 contains the identifiers of the vertical collections 144 holding documents containing the word “vacation.” The predicate defining the list, “term 1” in the above example, is referred to as the “head term.”

By considering all the terms in a collection of terms, vertical index 138 is constructed. There may be a large number of terms in the collection of terms. Vertical index 138 comprises vertical index lists 140, along with an efficient process for locating and returning the vertical index list 140 corresponding to a given attribute (search term). For example, a vertical index 138 can be defined containing vertical index lists 140 for all the words appearing in a collection. Vertical index 138 stores, for each given word in the collection, a vertical index list 140 of those vertical collections 144. Each such vertical collection 144 in the vertical index list 140 for the given word holds at least some documents containing the given word.

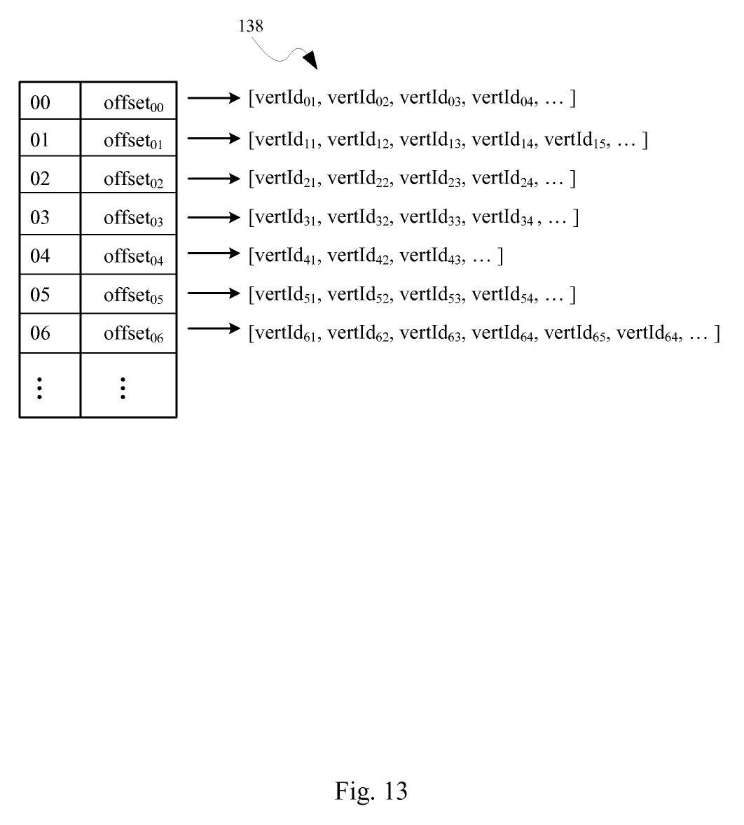

Referring to FIG. 13, a specific structure for vertical index 138 is provided in accordance with one embodiment of the present invention. In this embodiment, vertical index 138 comprises a hash lookup table and a vertical index list storage component. The hash lookup table contains pointers or file offsets that pinpoint the location of an individual vertical index list 140. A hash of a given head term (search term) provides the correct offset to corresponding list of vertical collections 144 that hold documents for the given head term. For example, consider the case in which the head term is “vacation.” The head term is hashed to give, in this example, the offset 03. A table lookup at offset 03 in vertical index 138 gives the list of identifiers {vertId₃₁, vertId₃₂, vertId₃₃, vertId₃₄, . . . } that correspond to the head term “vacation.” Each identifier in the set {vertId₃₁, vertId₃₂, vertId₃₃, vertId₃₄, } corresponds to a vertical collection 144 that contains documents with the “vacation” head term. Continuing to refer to FIG. 13, the vertical index lists are shown as having different lengths because that is the usual case. In some embodiments, a term specific score is associated with each vertical identifier in each vertical index list.

Steps for constructing a vertical index 138 have been detailed above. The vertical index 138 includes, for each respective head term in a collection of head terms, the list of vertical collections 144 having documents that contain the respective head term. To optimize vertical index 138, additional steps are taken in some embodiments to rank each vertical collection 144 referenced in each respective vertical index list 140 so that only the most significant vertical collections 144 are returned for any given search query. Methods for ranking vertical collections are disclosed in United States Patent Publication Number 20070244863 which is hereby incorporated by reference herein in its entirety.

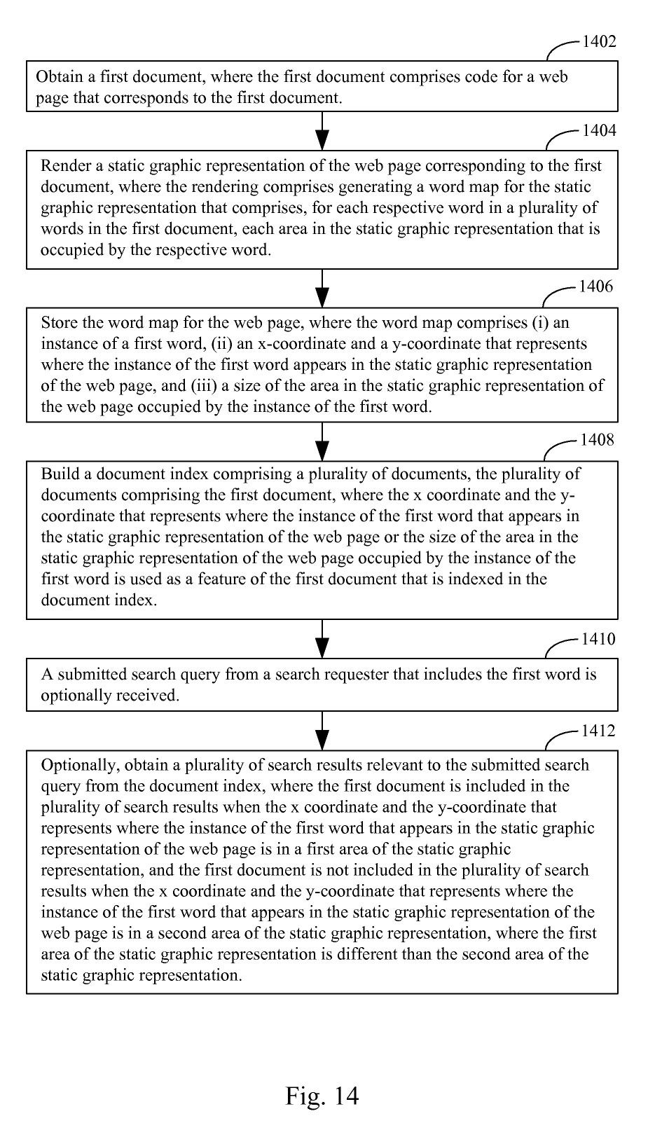

Referring to FIG. 14, an exemplary method in accordance with one embodiment of the present disclosure is described. The method details the steps taken to construct a document index 150. In step 1402, a first document is obtained. The first document comprises code for a web page (e.g., one that is available on the Internet or an Intranet) that corresponds to the respective document. In some instances the code for the web page makes use of web style sheets. In such instances, the page's semantic content and structure is defined by a markup language (e.g., HTML or XHTML) and the page's visual layout (style) is defined in an external stylesheet file using a language such as CSS or XSL. In such instances, the code for the web page is considered to be both the markup language code as well as the external stylesheet file code. Thus, as used herein, the code for a document includes any and all style sheets, embedded applets, complex JAVA scripts, and other complexities of code use to defined the web page that is obtained when the code for the document is rendered.

In step 1404, a static graphic representation of the web page of the first document is rendered. In other words, the code for the web page encoded by the document is parsed in order to construct the bitmapped or pixmapped image of the web page. During this parsing, each word that is to be rendered in the bitmapped or pixmapped image is identified. Any applicable style sheets, HTML features, Java code, or any other code or other attributes embedded in the code or referenced by the code in the document is fully interpreted during this parsing so that the bitmapped or pixmapped image of the web page is a true and exact replica of the web page encoded by the document. During this parsing, the exact size and location and appearance of each word that is to be rendered in the bitmapped or pixmapped image is determined. In this way, for each respective word in the plurality of words in the document, each area in the static graphic representation that is occupied by the respective word is determined. While such information is required for the bitmapped or pixmapped image it is also advantageously used to construct the word map 168 for the document.

In step 1406, the word map 168 obtained for the document is stored. In some a word map 168 is stored as illustrated in FIG. 1 in the context of vertical collections 144. That is, for each document identifier 146 in a vertical collection 144, the word map 168 for the document identifier is associated and stored in a data structure that contains the vertical collection 144. However, there is no requirement for the word map 168 and the static graphic representation 148 for a document to be stored in the same data structure, much less in a data structure that contains a vertical collection 144. First, storage of data in this way may be disadvantageous because a given document uniquely represented by a document identifier 146 may be in several different vertical collections 144. Thus, storage of the static graphic representation 148 and the word map 168 of a document along with a document identifier in each of the vertical collections 144 that the document appears in would lead to redundant storage of the static graphic representation 148 and the word map 168 and resultant inefficiency. FIG. 1 is merely used to exemplify the property that there is a word map 168 and a static graphic representation 148 for each document that are constructed, for example, using the methods disclosed above. One of skill in the art, upon the benefit of this disclosure, will appreciate that any of a number of ways may be used to electronically store word maps 168 and static graphic representations 148 of documents so that such constructs can be readily accessed when needed in subsequent steps disclosed below. For example, the word maps 168 and/or static graphic representations 148 can be stored in the document repository or standalone data structures or databases.

In exemplary step 1406 the word map for the web page of step 1402 is stored, where the word map comprises (i) an instance of a first word (that appears in the web page), (ii) an x-coordinate and a y-coordinate that represents where the instance of the first word appears in the static graphic representation of the web page, and (iii) a size of the area in the static graphic representation of the web page occupied by the instance of the first word. The contents of an exemplary word map 168 are shown in the following table reproduced from above:

| | | | | | | Font/ | Feature |
|---|---|---|---|---|---|---|---|
| | Instance | x-coordinate | y-coordinate | x-size | y-size | Point | (e.g., |
| Word | number | (pixels) | (pixels) | (pixels) | (pixels) | Size | attribute) |
| Hello | 1 | 125 | 300 | 10 | 400 | Times | Italic, |
| | | | | | | Roman/ | Underline |
| | | | | | | 12 | |
| | 2 | 497 | 400 | 12 | 400 | Times | Italic, |
| | | | | | | Roman/ | Underline |
| | | | | | | 10 | |
| Goodbye | 1 | 302 | 948 | 100 | 300 | Ariel/9 | Boldface |
| | 2 | 562 | 332 | 73 | 500 | Courier/9 | None |

In practice, steps 1402 through 1406 are done for several different web pages, thereby resulting in several different word maps 168, each for a different document in the plurality of documents. Furthermore, each such word map can comprise the location of one or more instances of each of a plurality of words that appear in the corresponding web page. In some embodiments, a word map 168 includes the location and size of five or more instances of a word, ten or more instance of a word, twenty or more instances of a word, or 100 or more instances of a word in a web page. In some embodiments, a word map 168 includes location information about five or more different words, ten or more different words, 100 or more different words, or 1000 or more different words that appear in a web page.

Referring to step 1408, a document index comprising a plurality of documents is constructed, the plurality of documents comprising the first document, where the x coordinate and the y-coordinate that represents where the instance of the first word appears in the static graphic representation of the web page or the size of the area in the static graphic representation of the web page occupied by the instance of the first word is used as a feature of the first document that is indexed in the document index. For example, in some embodiments, where the instance of the first word appears in the static graphic representation of the web page or the size of the area in the static graphic representation of the web page occupied by the instance of the first word is used as to determine a score for the first word, and this score is used when evaluating whether the document coding for the web page is relevant to a given search query. Either or both of these criteria can be used in the computation of a score for the word in the document coding for the web page, along with any combination of additional criteria such as (i) a number of times the first word appears in an upper portion of the document, (ii) a normalized average position of the first word within the document, (iii) a number of characters in the first word.

Optional steps 1410 and 1412 illustrate the point. In optional step 1410, a search query from a search requester is received. A search query typically comprises a list of one or more keywords, possibly joined by the Boolean operators AND, OR, as well as NOT, and optionally grouped with parentheses or quotes. Examples of search queries include: (i) “Florida discount vacations,” (ii) “The President of the United States,” “(car OR automobile) AND (transmission OR brakes),”and “boat.” A search query comprises any combination of alphanumeric and/or nonalphanumeric characters. Referring to FIG. 2, a search query is the contents of prompt 202 at a given time point. In some embodiments, the search query is in the form of an http request.

In optional step 1412, a plurality of search results relevant to the submitted search query are received from the document index 150, where the first document of step 1402 is included in the plurality of search results when the x-coordinate and the y-coordinate that represents where the instance of the first word that appears in the static graphic representation of the web page is in a first area of the static graphic representation and the first document is not included in the plurality of search results when the x-coordinate and the y-coordinate that represents where the instance of the first word that appears in the static graphic representation of the web page is in a second area of the static graphic representation, where the first area of the static graphic representation is different than the second area of the static graphic representation. More typically, the location of the first word in the document is simply used as one of many features that are used to score the relevance of a document to a search expression.

In an alternative to the illustrated steps 1410 and 1412 of FIG. 14, a submitted search query from a search requester that includes the first word is optionally received. A plurality of search results relevant to the submitted search query is optionally retrieved from the document index 150, where the first document of step 1402 is included in the plurality of search results when the size of the area in the static graphic representation of the web page occupied by the instance of the first word is greater than or equal to a first threshold size, and the second document is not included in the plurality of search results when the size of the area in the static graphic representation of the web page occupied by the instance of the first word is less than or equal to a first threshold size.

In another alternative to the illustrated steps 1410 and 1412 of FIG. 14, a submitted search query from a search requester that includes the first word is optionally received. A plurality of search results relevant to the submitted search query are optionally retrieved from the document index, where the determination of whether the first document is included in the plurality of search results is based, at least in part, upon a value of the x-coordinate and a value of the y-coordinate that represents where the instance of the first word that appears in the static graphic representation of the web page.

In another alternative to the illustrated steps 1410 and 1412 of FIG. 14, a submitted search query from a search requester that includes the first word is optionally received. A plurality of search results relevant to the submitted search query are optionally retrieved from the document index, where the determination of whether the first document is included in the plurality of search results is based, at least in part, upon a size of the area in the static graphic representation of the web page occupied by the instance of the first word.

In another alternative to the illustrated steps 1410 and 1412 of FIG. 14, a submitted search query from a search requester that includes the first word is optionally retrieved. A plurality of search results relevant to the submitted search query is optionally obtained from the document index 150, where the determination of whether the first document is included in the plurality of search results is based, at least in part, upon a number of times the first word appears in the first document.

In another alternative to the method illustrated in FIG. 14, a vertical index is constructed rather than or in addition to a document index using the principles outlined in FIG. 14. In such embodiments a first document is obtained, where the first document comprises code for a web page that corresponds to the first document. A static graphic representation of the web page corresponding to the first document is obtained, where the rendering comprises generating a word map for the static graphic representation that comprises, for each respective word in a plurality of words in the first document, each area in the static graphic representation that is occupied by the respective word. The word map for the web page is stored, where the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word. A vertical index comprising a plurality of documents is built. The plurality of documents comprises the first document, where the x-coordinate and the y-coordinate that represents where the instance of the first word that appears in the static graphic representation of the web page or the size of the area in the static graphic representation of the web page occupied by the instance of the first word is used as a feature of the first document that is indexed in the vertical index.

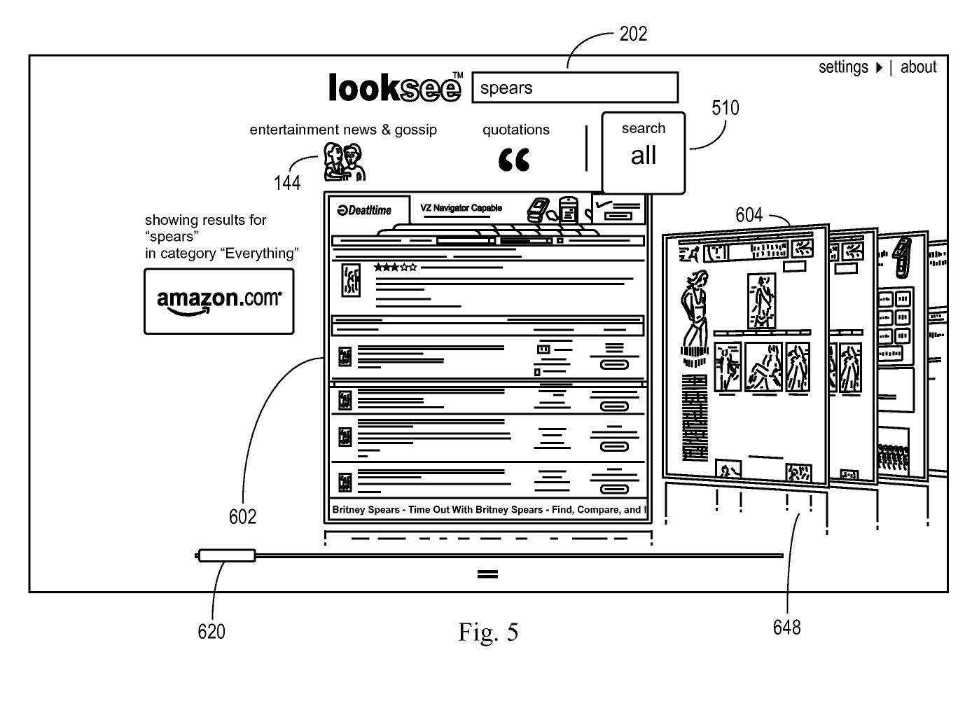

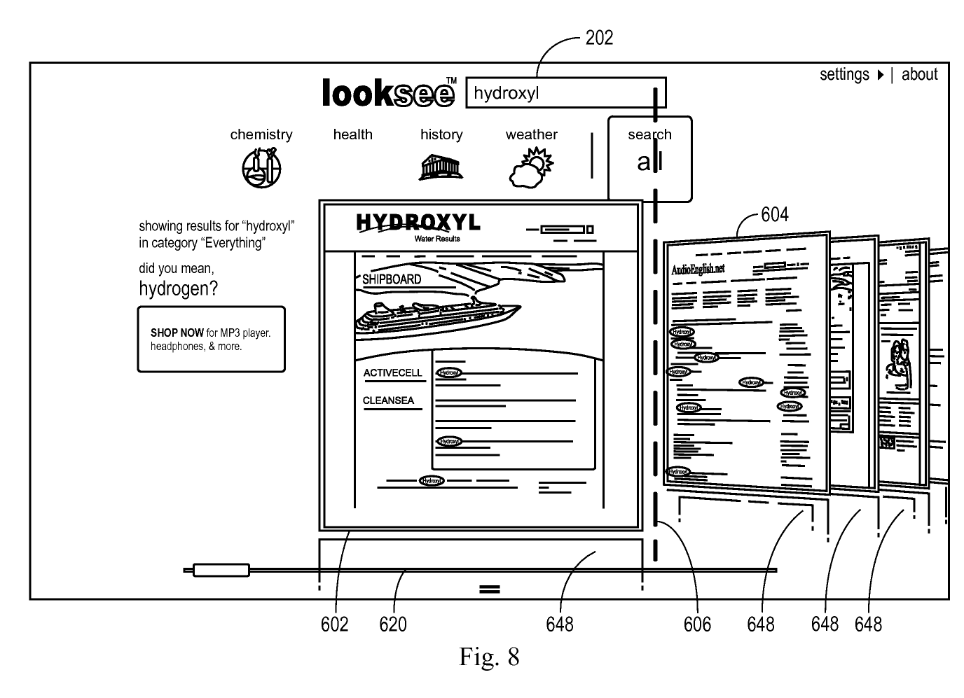

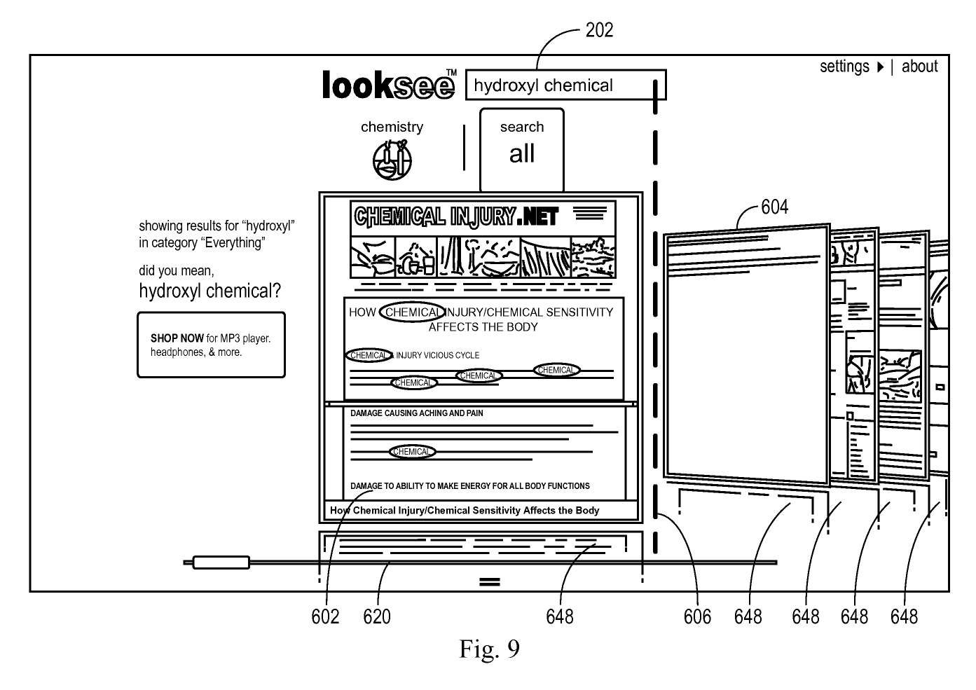

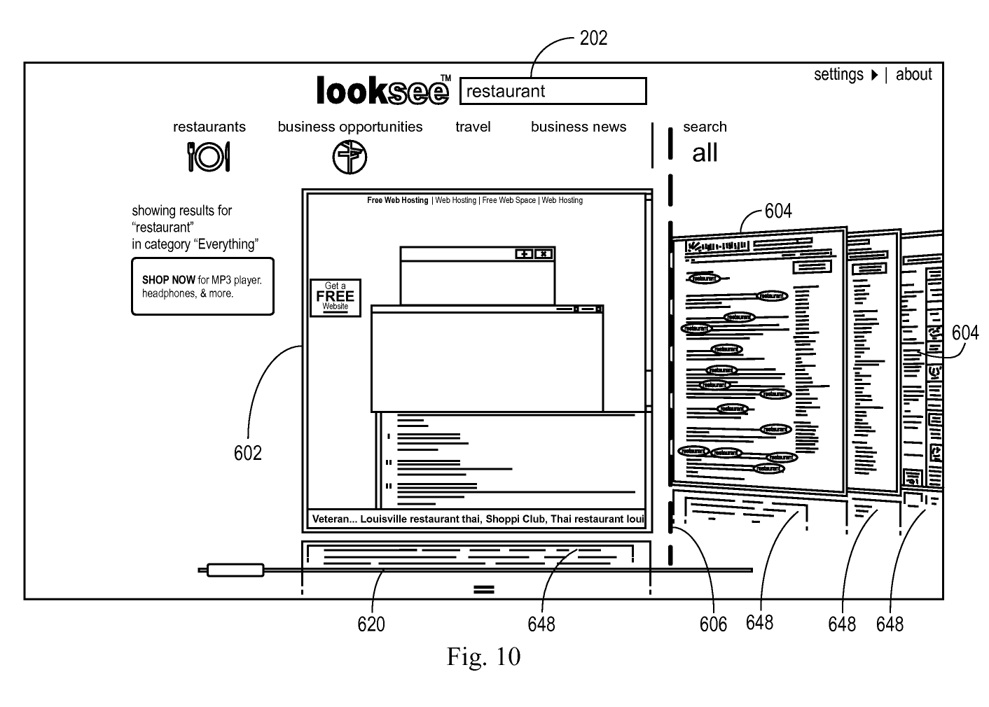

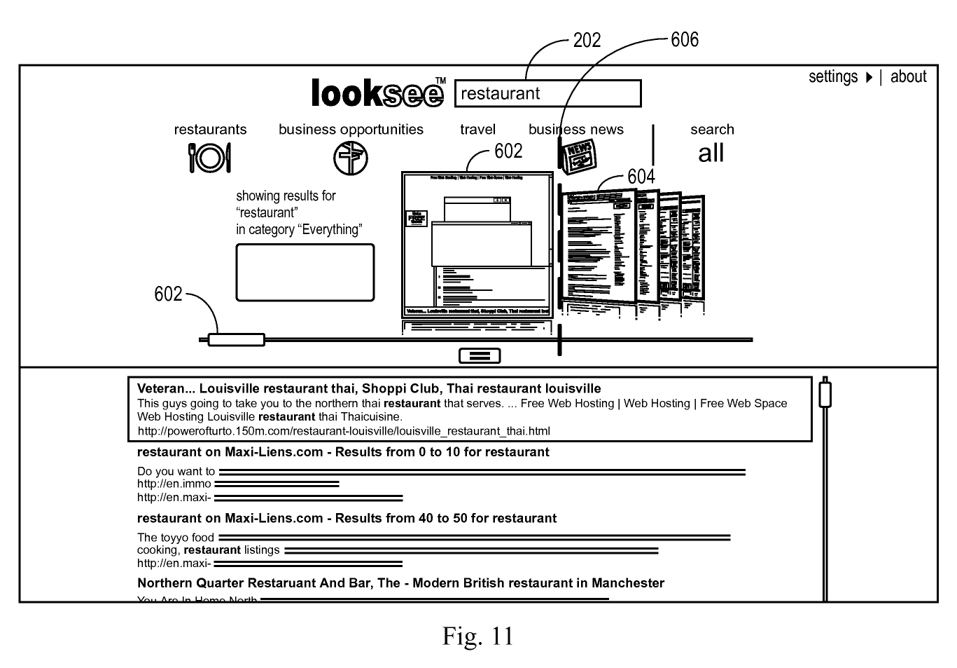

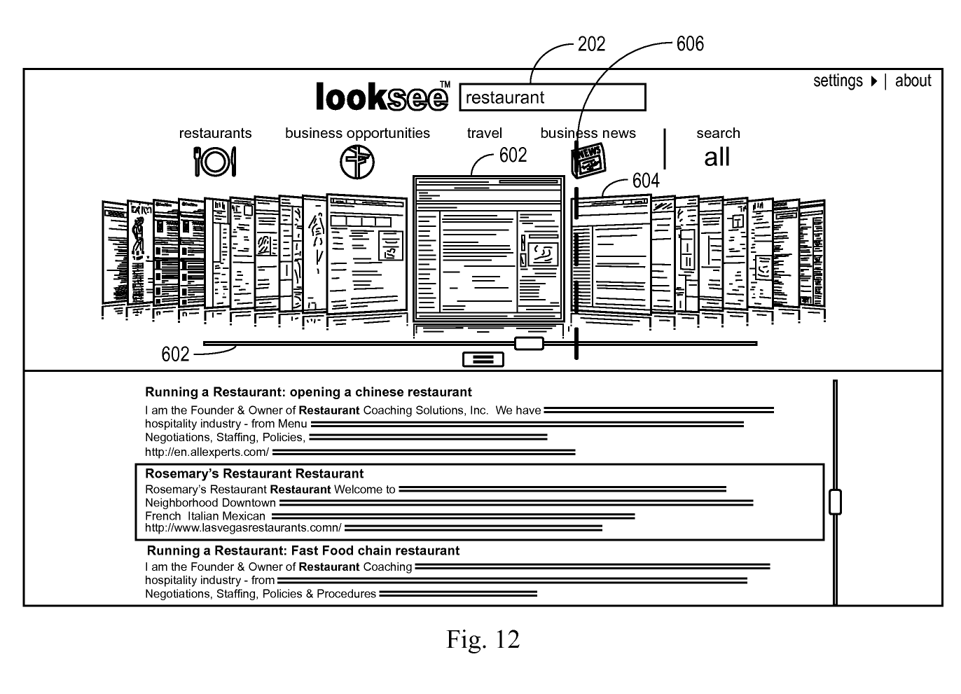

As a result of optional steps 1410 and 1412, high ranking documents are reported to client computer 100 where they are displayed, for example, as shown in FIGS. 5-12, in accordance with instructions provided from display module 36 to web browser 34. In some embodiments, display module 36 and web browser 34 are, in fact, integrated into the same program. In some embodiments, display module 36 and web browser 34 are different programs. Thus, in summary, a submitted search query is received from a search requester on a client computer 100. Then, as described above, the search query is processed to obtain search results relevant to the submitted search query and these search results are submitted to the client device 100. In some embodiments, each search result in the plurality of search results comprises: (i) a source document or a reference to a source document 152, (ii) a static graphic representation 148 of the source document (where the static graphic representation 154 of the source document was obtained from the source document at a time before the submitted search query was received), and (iii) the location of where the words in the original search query appear in the static graphic representation 148. The location of where the words in the original search query appear in the static graphic representation of a given search result (document) are obtained from the word map 168 for the document. In some embodiments, each search result in the plurality of search results comprises: (i) a source document or a reference to a source document 152, (ii) an annotated static graphic representation 148 of the source document (where the static graphic representation 154 of the source document was obtained from the source document at a time before the submitted search query was received) in which the location of where the words in the original search query appear in the static graphic representation 148 appear are annotated by highlighting or any other annotation form known in the art. The location of where the words in the original search query appear in the static graphic representation of a given search result (document) are obtained from the word map 168 for the document.

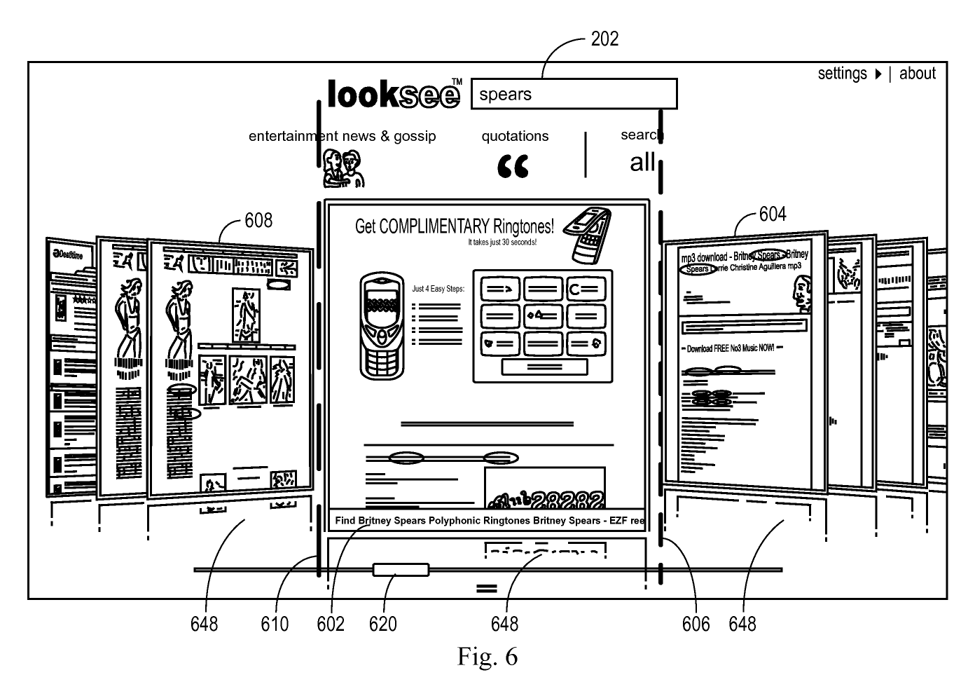

As illustrated in FIG. 6, a static graphic representation of a search result in the plurality of search results is displayed, where the displaying step comprises (i) using the word map for the static graphic representation to identify each area in the static graphic representation that is occupied by a word in the submitted search query and (ii) highlighting each area in the static graphic representation that is occupied by a word in the submitted search query. In FIG. 6, each area in the static graphic representation that is occupied by the search query “spears” in the submitted search query is highlighted in yellow. The yellowed areas in the static graphic representation are illustrated by black or white ovals.

In some embodiments, a submitted search query is received from a search requester and a plurality of search results relevant to the submitted search query is obtained from the document index, where each respective search result in at least a portion of the plurality of search results comprises the static graphic representation 148 of a document corresponding to the respective search result created in the rendering step 1404 in the plurality of documents. Then, as illustrated in FIG. 6, a static graphic representation 602 of a first search result in the plurality of search results is displayed in a center position 602 of a graphic output device where the displaying step comprises (i) using the word map 168 for the first static graphic representation to identify each area in the static graphic representation that is occupied by a word in the submitted search query and (ii) highlighting each area in the static graphic representation in the center position 602 that is occupied by a word in the submitted search query. In some embodiments of the present disclosure and as further illustrated in FIG. 6, another static graphic representation of a second search result in the plurality of search results is displayed in a first off-center position 604 of the graphic output device (to the right of the center position 602 in the case of FIG. 6, to the left of the center position in other embodiments) where the displaying step further comprises (i) using the word map 168 for the static graphic representation 148 generated in the rendering step 1404 that is occupying position 604 to identify each area in the static graphic representation at position 604 that is occupied by a word in the submitted search query and (ii) highlighting each area in the static graphic representation in position 604 that is occupied by a word in the submitted search query, where the static graphic representation at position 604 is displayed rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a first axis of rotation 606 that lies between the center position 602 and the first off-center position 604 of the graphic output device in the manner illustrated, for example, in FIG. 6.

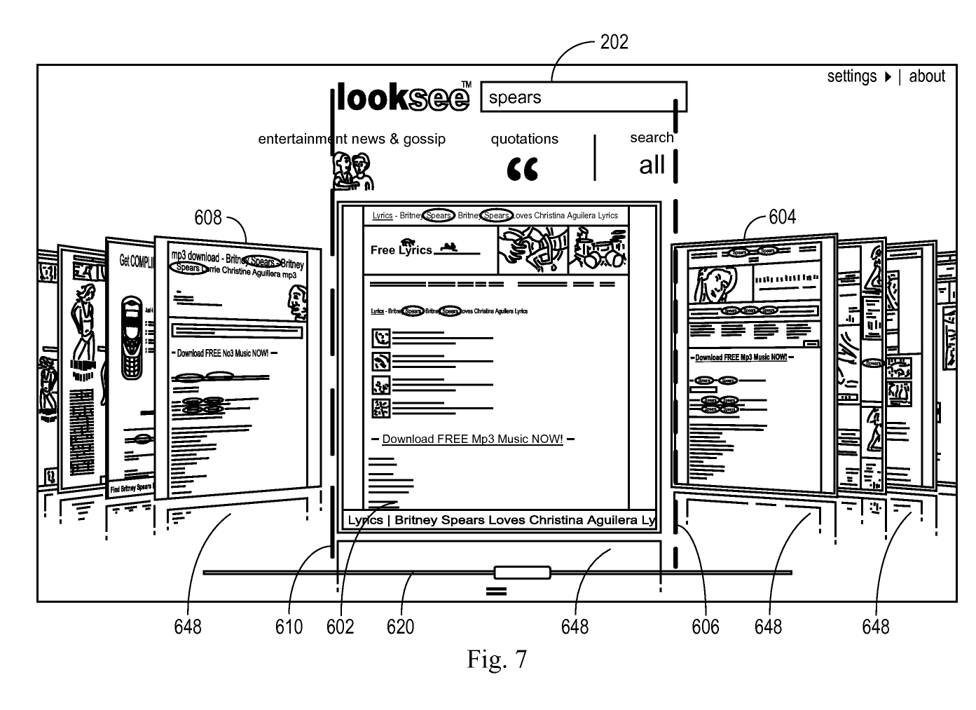

Referring to FIG. 6, in some embodiments, responsive to a selection of the static graphic representation of the source document in the first off-center position 604, the search result at position 604 is shifted from the first off-center position 604 to the center position 602. This transition from the first off-center position 604 to the center position 602 is illustrated by FIGS. 6 and 7 where a user has clicked on the static graphic representation in position 604 twice so that documents have shifted to the left twice in the transition from FIG. 6 to FIG. 7.

Referring to FIG. 5, in some embodiments, in the initial display of search results, one search result is displayed in the center position 602 and all the remaining search results are cascaded to the right of the center position 602 on the display. The set of search results cascaded to the right of the center position of the display includes a static graphic representation at first off-center position 604. Responsive to a selection of the static graphic representation in first off-center position 604 (or any of the static graphic representations cascaded to the right of the first off-center position 604), the static graphic representation in the center position 602 in FIG. 5 is shifted to a second off-center position 608 of the graphic output device (as seen in FIG. 6), thereby causing the static graphic representation that was in center position 602 to now be displayed at the second off-center position 608 rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a second axis of rotation 610 that lies between the center position 602 and the second off-center position 608 of the graphic output device. As part of this action, the static graphic representation occupying first off-center position 604 in FIG. 5 is shifted to the center position (at position 602) of the graphic output device where it is now displayed in a manner that is no longer rotated about the first axis of rotation 606. As further part of this action, a static graphic representation of a third search result in the plurality of search results is now displayed in the first off-center position 604 of the graphic output device rotated about the first axis of rotation 606. The movements described here are illustrated in the transition from FIG. 5 to FIG. 6, where the static graphic position in position 604 has been selected twice, so that each static graphic representation has shifted two positions to the left. In other words, the steps outlined above in this paragraph each occur twice.

Just as graphic representations can be shifted from the first off-center position 604, to the center position 602, and then to the second off-center position 608, the reverse is also true. When a user clicks on a graphic representation occupying the second off-center position 608, the graphic representation occupying the second off-center position 608 is shifted to the center position 602 and the graphic representation formally occupying the center position 602 is shifted to the first off-center position 604. Thus, in the above-identified manner, a user can easily view the graphic representation of search result hits in a seamless and efficient manner.

In some embodiments, responsive to a selection of the static representation of the source document of the search result occupying the center position 602 of the graphic output device 6, the size of the static graphic representation is enlarged. For instance, in some embodiments, the static representation of the source document is enlarged by at least 10 percent, at least 20 percent, at least 30 percent, or at least 100 percent. Furthermore, responsive to a selection of a portion of the graphic output device 6 outside of the static representation of the source document occupying the center position 602 while it is in its enlarged state, the size of the static graphic representation of the source document is reduced back to the original size that it was before it was enlarged.

In some embodiments, responsive to a selection of the static representation occupying the center position 602, a web page impression from the source document of the first search result is retrieved. In other words, a “live” version of the document obtained from the URL or other address where the document was found while building the document index 150 is obtained and used to replace the static graphic representation of the source document.

In some embodiments, responsive to a selection of the static representation of the source document of the search result occupying the center position 602 of the graphic output device, the static graphic representation of the source document is flipped from a first side to a reverse side so that the reverse side of the static graphic representation is shown. In some embodiments, the reverse side of the static graphic representation contains information associated with the static graphic representation (e.g., source of document, size of document, file type of document, a date and/or time when static graphic representation of document was created, a date and/or time when the document was accessed during a web crawl, etc.). In some embodiments, the static graphic representation is flipped to the opposite side each time a first designated portion of the static graphic representation is selected (e.g., the top portion) and is enlarged when a second designated portion of the static graphic representation is selected (e.g., anything outside of the top portion).

In some instances, a toggle bar 620 is provided. See, for example, FIG. 6. When the search requester pulls the toggle bar 620 in a first direction (e.g., to the left), the displayed static graphic representations of the search results shift from the first off-center position 604 to the center position 602, and from the center position 602 to the second off-center position 608 responsive to the pull in the first direction. When the search requester pulls the toggle bar in a second direction (e.g., to the right), the static graphic representations of search results shift from the second off-center position 608 to the center position 602, and from the center position 602 to the first off-center position 604 responsive to the pull in the second direction.

In some embodiment, one of the graphic representations displays in the first off-center position 604, the center position 602, or the second off-center position 608 is an advertisement. In other words, rather than being a “hit” to a search query that was obtained from a vertical collection 144 or a document index 150, the graphic representation is an advertisement for services or products that may or may not be related to the search query. In some embodiments, the use of advertisements in this manner is accomplished by embedding the advertisement into the plurality of search results as a static graphic representation so that, when the search requester pulls the toggle bar 620 in the first direction or the second direction, an advertisement is displayed in the center position 602.

In some embodiments, responsive to a selection and drag of the static graphic representation of the source document occupying the first off-center position 604, the center position, or the second off-center position 608, a copy of the static graphic representation of the source document of the first search result is stored in a predetermined or user specified location on the client device (e.g., a location in memory 20 and/or memory 114 of client device 100). This is advantageous for storing the static graphic representation of hits to search queries.

In some embodiments, when the static graphic representation occupying the center position 602 is displayed for a predetermined amount of time without user input (e.g., for two seconds or more, for three seconds or more, for five seconds or more) the static graphic representation is automatically transformed, without user input, to a live impression from the source document.

In some embodiments, one or more advertisements are embedded into the plurality of search results returned to a device 100 by search engine server 178 as static graphic representations. In some embodiments, a static graphic representation of a source document is a graphic representation of an entire web page at a time before the submitted search query was received. In some embodiments, the displaying step 1416 further comprises displaying a reflection 648 of the static graphic representation below the static graphic representation. A reflection 648 is illustrated in FIG. 5-13.

Referring to FIGS. 5 and 14, in some embodiments, steps 1412 through 1416 comprises (i) receiving a submitted search query from a search requester, (ii) obtaining a plurality of search results relevant to the submitted search query from the document index, where each respective search result in at least a portion of the plurality of search results comprises the static graphic representation of a document corresponding to the respective search result created in the rendering step 1404 in the plurality of documents, where the step further comprises embedding an interactive widget as a search result in the plurality of search results, and (iii) displaying a first static graphic representation of a search result in the plurality of search results in a center position 602 of a graphic output device 6. In such embodiments, the displaying step comprises (i) using the word map 168 for the static graphic representation generated in the rendering step 1404 to identify each area in the static graphic representation in the center position 602 that is occupied by a word in the submitted search query and (ii) highlighting each area in the static graphic representation in the center position 602 that is occupied by a word in the submitted search query. In such embodiments, the displaying step further comprises displaying a static graphic representation of each of one or more search results in the plurality of search results, other than the static graphic representation displayed in the center position 602, in a plurality of off-center positions 604 of the graphic output device, where a search result in the one or more search results is the interactive widget, and where the static graphic representations of the one or more search results in the plurality of search results in the plurality of off-center positions of the graphic output device are rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a first axis of rotation 606 that lies between the center position 602 and the plurality of off-center positions 604 of the graphic output device.

In some embodiments, each of the documents in document index 150 and/or a vertical collection 144 that have been used by search engine 136 to perform a search based upon the search query provided by the user, are independently classified into one or more categories. For example the first document in the search results may be deemed to in categories one, three, five, and seven (e.g., sports, major league baseball, blogs, and news) and the second document in the search results may be deemed to be in categories five and seven (blogs and news). Such categorization provides advantages. For example, the search requester can request to remove a particular search result from the plurality of search results that were obtained in response to the user's original search query. For example, consider the above case in which the categories of the first document and the second document are described. Suppose that the search request removes the second document. In response to this request, the original search query is resubmitted with the specific request to not retrieve documents that are only in the blogs category or are only in the news category (or are only in both the blogs category and the news category). As a result, new search results relevant to the modified search query are obtained. Advantageously, the new search results are focused on the categories of documents in document index 150 or vertical collection 144 that the user did not exclude from the search.

In typical embodiments, the static graphic representation of the source document of each of the hits in the search results is a graphic representation of an entire web page taken from the location where the source document resides at a time before the submitted search query was received. For instance, the graphic representation of the entire web page may be taken when the source document is crawled during construction of the vertical collection.

In some embodiments, the method further comprises receiving, prior to obtaining the search results, a designation of a vertical collection in a plurality of vertical collections from the search requester. For instance, the user can select any of the icons for vertical collections 144 that are illustrated in FIGS. 3 through 12. In such embodiments, the search query and the designation of the vertical collection is submitted to search engine server 178. Responsive to this request from the user, search engine 136 (or a specialized search engine used to search the designated vertical collection 144) searches the designated vertical collection 144 with the search query and returns a plurality of search results to the client 100.

In some embodiments, responsive to a search query from a search requester, client 100 submits the search query to search engine server 178 without a designation of a vertical collection 144. In such instances, search engine 136 of search engine server 178 searches document index 150 using the search query and provides the search results back to client 100. Client 100 then displays the plurality of search results from the search engine server 178. In such embodiments, the document index that is searched, document index 150, is representative of the entire Internet (e.g., document index 150 is a random sampling of all the documents addressable by the Internet). This means that, typically, the documents in document index 150 are not restricted to a particular category of documents, such as sports, but rather can be of any category found in the Internet. In some embodiments, offensive documents are excluded from document index 150.

Still another aspect of the present application provides a computer program product for use in conjunction with a computer system, the computer program product comprising a computer readable storage medium and a computer program mechanism embedded therein, the computer program mechanism comprising instructions for performing any of the methods disclosed herein. For instance, in one embodiment, the computer program mechanism comprises instructions for obtaining a first document, where the first document comprises code for a web page that corresponds to the first document and instructions for rendering a static graphic representation of the web page corresponding to the first document, where the rendering comprises generating a word map for the static graphic representation that comprises, for each respective word in a plurality of words in the first document, each area in the static graphic representation that is occupied by the respective word. The computer program mechanism further comprises instructions for storing the word map for the web page, where the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word. The computer program mechanism further comprises instructions for building a document index or a vertical index of a plurality of documents, the plurality of documents comprising the first document, where the x-coordinate and the y-coordinate that represents where the instance of the first word that appears in the static graphic representation of the web page or the size of the area in the static graphic representation of the web page occupied by the instance of the first word is used as a feature of the first document that is indexed in the document index or the vertical index.

Another aspect of the present invention comprises a computer comprising a main memory, a processor and one or more programs (e.g. display module 36) stored in the main memory and executed by the processor that includes instructions for performing any of the methods disclosed herein. For example, in one embodiment, the one or more programs collectively include instructions for obtaining a first document, where the first document comprises code for a web page that corresponds to the first document and instructions for rendering a static graphic representation of the web page corresponding to the first document, where the rendering comprises generating a word map for the static graphic representation that comprises, for each respective word in a plurality of words in the first document, each area in the static graphic representation that is occupied by the respective word. The one or more programs further collectively include instructions for storing the word map for the web page, where the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word. The one or more programs further collectively include instructions for building a document index or a vertical index of a plurality of documents, the plurality of documents comprising the first document, where the x-coordinate and the y-coordinate that represents where the instance of the first word that appears in the static graphic representation of the web page or the size of the area in the static graphic representation of the web page occupied by the instance of the first word is used as a feature of the first document that is indexed in the document index or the vertical index.

Still another aspect of the present application provides a system for providing search results responsive to a search query that comprises means for carrying out any of the methods disclosed in the instant application. One embodiment of such a system is illustrated in FIG. 1 and describe above. In one embodiment, such a system comprises means for obtaining a first document, where the first document comprises code for a web page that corresponds to the first document and instructions for rendering a static graphic representation of the web page corresponding to the first document, where the rendering comprises generating a word map for the static graphic representation that comprises, for each respective word in a plurality of words in the first document, each area in the static graphic representation that is occupied by the respective word. The system further comprises means for storing the word map for the web page, where the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word. The system further comprises means for building a document index or a vertical index of a plurality of documents, the plurality of documents comprising the first document, where the x-coordinate and the y-coordinate that represents where the instance of the first word that appears in the static graphic representation of the web page or the size of the area in the static graphic representation of the web page occupied by the instance of the first word is used as a feature of the first document that is indexed in the document index or the vertical index.

### Vertical Collections are Optional

The use of vertical collections 144 is entirely optional in the present disclosure. Thus, the present disclosure specifically encompasses embodiments that do not make use over vertical collections. In such embodiments, icons for vertical collections 144 are not displayed on client device 100.

### References Cited and Alternative Embodiments

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a computer readable storage medium. For instance, the computer program product could contain the program modules shown in FIG. 1. These program modules can be stored on a CD-ROM, DVD, magnetic disk storage product, or any other computer readable data or program storage product. The software modules in the computer program product may also be distributed electronically, via the Internet or otherwise, by transmission of a computer data signal (in which the software modules are embedded).

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A method for building a document index or a vertical index, the method comprising:
(A) obtaining a first document, wherein the first document comprises code for a web page that corresponds to the first document;
(B) rendering a static graphic representation of the web page corresponding to the first document, wherein the rendering comprises generating a word map for the static graphic representation that comprises, for each respective word in a plurality of words in the first document, each area in the static graphic representation that is occupied by the respective word;
(C) storing the word map for the web page, wherein the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word; and
(D) building the document index or the vertical index comprising a plurality of documents, the plurality of documents comprising the first document, wherein the x-coordinate and the y-coordinate that represents where the instance of the first word that appears in the static graphic representation of the web page or the size of the area in the static graphic representation of the web page occupied by the instance of the first word is used as a feature of the first document that is indexed in the document index or the vertical index.

2. The method of claim 1, the method further comprising:
(E) receiving a submitted search query from a search requester that includes the first word; and
(F) obtaining a plurality of search results relevant to the submitted search query from the document index or the vertical index, wherein
the first document is included in the plurality of search results when the x-coordinate and the y-coordinate that represents where the instance of the first word that appears in the static graphic representation of the web page is in a first area of the static graphic representation, and
the first document is not included in the plurality of search results when the x-coordinate and the y-coordinate that represents where the instance of the first word that appears in the static graphic representation of the web page is in a second area of the static graphic representation, wherein the first area of the static graphic representation is different than the second area of the static graphic representation.

3. The method of claim 1, the method further comprising:
(E) receiving a submitted search query from a search requester that includes the first word; and
(F) obtaining a plurality of search results relevant to the submitted search query from the document index or the vertical index, wherein
the first document is included in the plurality of search results when the size of the area in the static graphic representation of the web page occupied by the instance of the first word is greater than or equal to a first threshold size, and
the second document is not included in the plurality of search results when the size of the area in the static graphic representation of the web page occupied by the instance of the first word is less than or equal to a first threshold size.

4. The method of claim 1, the method further comprising:
(E) receiving a submitted search query from a search requester that includes the first word; and
(F) obtaining a plurality of search results relevant to the submitted search query from the document index or the vertical index, wherein the determination of whether the first document is included in the plurality of search results is based, at least in part, upon a value of the x-coordinate and a value of the y-coordinate that represents where the instance of the first word that appears in the static graphic representation of the web page.

5. The method of claim 1, the method further comprising:
(E) receiving a submitted search query from a search requester that includes the first word; and
(F) obtaining a plurality of search results relevant to the submitted search query from the document index or the vertical index, wherein the determination of whether the first document is included in the plurality of search results is based, at least in part, upon a size of the area in the static graphic representation of the web page occupied by the instance of the first word.

6. The method of claim 1, the method further comprising:
(E) receiving a submitted search query from a search requester that includes the first word; and
(F) obtaining a plurality of search results relevant to the submitted search query from the document index or the vertical index, wherein the determination of whether the first document is included in the plurality of search results is based, at least in part, upon a number of times the first word appears in the first document.

7. A computer program product for use in conjunction with a computer system, the computer program product comprising a computer readable storage medium and a computer program mechanism embedded therein, the computer program mechanism comprising:
(A) instructions for obtaining a first document, wherein the first document comprises code for a web page that corresponds to the first document;
(B) instructions for rendering a static graphic representation of the web page corresponding to the first document, wherein the rendering comprises generating a word map for the static graphic representation that comprises, for each respective word in a plurality of words in the first document, each area in the static graphic representation that is occupied by the respective word;
(C) instructions for storing the word map for the web page, wherein the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word; and
(D) instructions for building a document index or a vertical index of a plurality of documents, the plurality of documents comprising the first document, wherein the x-coordinate and the y-coordinate that represents where the instance of the first word that appears in the static graphic representation of the web page or the size of the area in the static graphic representation of the web page occupied by the instance of the first word is used as a feature of the first document that is indexed in the document index or the vertical index.

8. The computer program product of claim 7, the computer program mechanism further comprising:
(E) instructions for receiving a submitted search query from a search requester that includes the first word; and
(F) instructions for obtaining a plurality of search results relevant to the submitted search query from the document index or the vertical index, wherein
the first document is included in the plurality of search results when the x-coordinate and the y-coordinate that represents where the instance of the first word that appears in the static graphic representation of the web page is in a first area of the static graphic representation, and
the first document is not included in the plurality of search results when the x-coordinate and the y-coordinate that represents where the instance of the first word that appears in the static graphic representation of the web page is in a second area of the static graphic representation, wherein the first area of the static graphic representation is different than the second area of the static graphic representation.

9. The computer program product of claim 7, the computer program mechanism further comprising:
(E) instructions for receiving a submitted search query from a search requester that includes the first word; and
(F) instructions for obtaining a plurality of search results relevant to the submitted search query from the document index or the vertical index, wherein
the first document is included in the plurality of search results when the size of the area in the static graphic representation of the web page occupied by the instance of the first word is greater than or equal to a first threshold size, and
the second document is not included in the plurality of search results when the size of the area in the static graphic representation of the web page occupied by the instance of the first word is less than or equal to a first threshold size.

10. The computer program product of claim 8, the computer program mechanism further comprising:
(E) instructions for receiving a submitted search query from a search requester that includes the first word; and
(F) instruction for obtaining a plurality of search results relevant to the submitted search query from the document index or the vertical index, wherein the determination of whether the first document is included in the plurality of search results is based, at least in part, upon a value of the x-coordinate and a value of the y-coordinate that represents where the instance of the first word that appears in the static graphic representation of the web page.

11. The computer program product of claim 8, the computer program mechanism further comprising:
(E) instructions for receiving a submitted search query from a search requester that includes the first word; and
(F) instructions for obtaining a plurality of search results relevant to the submitted search query from the document index or the vertical index, wherein the determination of whether the first document is included in the plurality of search results is based, at least in part, upon a size of the area in the static graphic representation of the web page occupied by the instance of the first word.

12. The computer program product of claim 8, the computer program mechanism further comprising:
(E) instructions for receiving a submitted search query from a search requester that includes the first word; and
(F) instructions for obtaining a plurality of search results relevant to the submitted search query from the document index or the vertical index, wherein the determination of whether the first document is included in the plurality of search results is based, at least in part, upon a number of times the first word appears in the first document.

13. A computer, comprising:
a main memory;
a processor;
and one or more programs, stored in the main memory and executed by the processor, the one or more programs collectively including instructions for:
(A) obtaining a first document, wherein the first document comprises code for a web page that corresponds to the first document;
(B) rendering a static graphic representation of the web page corresponding to the first document, wherein the rendering comprises generating a word map for the static graphic representation that comprises, for each respective word in a plurality of words in the first document, each area in the static graphic representation that is occupied by the respective word;
(C) storing the word map for the web page, wherein the word map comprises (i) an instance of a first word, (ii) an x-coordinate and a y-coordinate that represents where the instance of the first word appears in the static graphic representation of the web page, and (iii) a size of the area in the static graphic representation of the web page occupied by the instance of the first word; and
(D) building a document index or a vertical index of a plurality of documents, the plurality of documents comprising the first document, wherein the x-coordinate and the y-coordinate that represents where the instance of the first word that appears in the static graphic representation of the web page or the size of the area in the static graphic representation of the web page occupied by the instance of the first word is used as a feature of the first document that is indexed in the document index or the vertical index.

14. The computer of claim 13, the one or more programs further collectively including instructions for:
(E) receiving a submitted search query from a search requester that includes the first word; and
(F) obtaining a plurality of search results relevant to the submitted search query from the document index or the vertical index, wherein
the first document is included in the plurality of search results when the x-coordinate and the y-coordinate that represents where the instance of the first word that appears in the static graphic representation of the web page is in a first area of the static graphic representation, and
the first document is not included in the plurality of search results when the x-coordinate and the y-coordinate that represents where the instance of the first word that appears in the static graphic representation of the web page is in a second area of the static graphic representation, wherein the first area of the static graphic representation is different than the second area of the static graphic representation.

15. The computer of claim 13, the one or more programs further collectively including instructions for
(E) receiving a submitted search query from a search requester that includes the first word; and
(F) obtaining a plurality of search results relevant to the submitted search query from the document index or the vertical index, wherein
the first document is included in the plurality of search results when the size of the area in the static graphic representation of the web page occupied by the instance of the first word is greater than or equal to a first threshold size, and
the second document is not included in the plurality of search results when the size of the area in the static graphic representation of the web page occupied by the instance of the first word is less than or equal to a first threshold size.

16. The computer of claim 13, the one or more programs further collectively including instructions for
(E) receiving a submitted search query from a search requester that includes the first word; and
(F) obtaining a plurality of search results relevant to the submitted search query from the document index or the vertical index, wherein the determination of whether the first document is included in the plurality of search results is based, at least in part, upon a value of the x-coordinate and a value of the y-coordinate that represents where the instance of the first word that appears in the static graphic representation of the web page.

17. The computer of claim 13, the one or more programs further collectively including instructions for:
(E) receiving a submitted search query from a search requester that includes the first word; and
(F) obtaining a plurality of search results relevant to the submitted search query from the document index or the vertical index, wherein the determination of whether the first document is included in the plurality of search results is based, at least in part, upon a size of the area in the static graphic representation of the web page occupied by the instance of the first word.

18. The computer of claim 13, the one or more programs further collectively including instructions for:
(E) receiving a submitted search query from a search requester that includes the first word; and
(F) obtaining a plurality of search results relevant to the submitted search query from the document index or the vertical index, wherein the determination of whether the first document is included in the plurality of search results is based, at least in part, upon a number of times the first word appears in the first document.

19. The method of claim 1, wherein the document is available on the Internet.

20. The computer program product of claim 7, wherein the document is available on the Internet.

21. The computer of claim 13, wherein the document is available on the Internet.

22. The method of claim 1, wherein the document index is built.

23. The computer program product of claim 7, wherein the document index is built.

24. The computer of claim 13, wherein the document is built.

25. The method of claim 1, wherein the vertical collection is built.

26. The computer program product of claim 7, wherein the vertical collection is built.

27. The computer of claim 13, wherein the vertical collection is built.
